(19) United States
(12) Patent Application Publication
(10) Pub. No.: US 2009/0028754 A1
(43) Pub. Date: Jan. 29, 2009

(54) Insert for Restraining Tube Rotation in a Sample Tube Rack

(75) Inventor: Frank Jay Robb, Middletown, DE (US)

Correspondence Address: DADE BEHRING INC.;LEGAL DEPARTMENT, 1717 DEERFIELD ROAD, DEERFIELD, IL, 60015, US

(73) Assignee: DADE BEHRING INC., Deerfield, IL (US)

(21) Appl. No.: 11/829,350

(22) Filed: Jul. 27, 2007

(51) Int. Cl. G01N 35/02; B01L 9/00

(52) U.S. Cl. 422/65; 422/104

(57) ABSTRACT

A sample tube carrier insert having a bottom portions with opposing projections vertically extending above bottom portion so that an interference-fit is formed between the bottom of a sample tube carried by the carrier and the projections to prevent undesirable rotation of the tube.

### FIELD OF THE INVENTION

The present invention relates to automated clinical sample conveyor systems and methods for handling patient samples carried in tubes. More particularly, the present invention relates to an insert for sample tube carrier to increase reliability of identifying the identity of a sample tube carried therein. The present invention has particular utility in automated sample handling conveyor systems and associated devices provided for pre-treating blood, physiological fluids, and other biological samples prior to analysis.

### BACKGROUND OF THE INVENTION

Clinical diagnostic analyzers are being developed with increasing levels of complexity and sophistication in order to fully automated the performance of chemical assays and immunoassays of biological fluid samples such as urine, blood serum, plasma, cerebrospinal liquids and the like, these fluid samples almost universally being contained in open or capped sample tubes. Generally, chemical reactions between an analyte in a patient's biological sample and reagents used during performing the assay result in generating various signals that can be measured by the analyzer. From these signals the concentration of the analyte in the sample may be calculated.

A wide variety of automated chemical analyzers are known in the art and are continually being improved to increase analytical menu and efficiency, reduce turnaround time, and decrease requisite sample volumes. See for example, U.S. Pat. No. 6,723,288 assigned to the assignee of the present application. Such improvements, while necessary in themselves, may be hampered if sufficient corresponding advances are not made in the areas of pre-analytical sample preparation and handling. Sample preparation includes sorting, batch preparation, centrifugation of sample tubes to separate sample constituents, cap removal to facilitate fluid access, and the like.

Automated sample handling systems generally include the use of conveyor systems for conveying specimens to analyzers, such as those described in U.S. Pat. Nos. 5,178,834, and 5,209,903, and U.S. Pat. No. 6,060,022, wherein the sample handling system is adapted to automatically present pre-treated samples in open containers to robotic devices operated in conjunction with independent stand-alone analyzers. In order to handle the transportation, alignment, and tracking needs of large numbers of sample tubes effectively, sample handling systems often utilize multi-tube carrying racks which are organized and loaded with sample tubes in tube chambers prior to being placed into the sample handling systems, like described in U.S. Pat. No. 6,123,205. An alternative approach is the use of individual sample tube carriers which may be robotically placed onto conveyor lines, like described in U.S. Pat. No. 5,897,090.

Regardless of which approach is employed for supporting sample tubes transported throughout sample handling systems, it is imperative that provision be made for tracking the location of each and every sample tube. Generally this is accomplished by affixing a unique, machine-readable label to each tube and tracking the location of the tube with automatic label scanning devices distributed appropriately throughout the sample handling system. To facilitate scanning of the label, at least one opening is provided in individual sample tube carrier or in each sample tube chamber. In particular, sample tube racks and carriers generally have a vertical opening to enable a bar code reader to read a linear bar code affixed to each tube in order to identify the patient's identity. These markings are generally 1-D, rectilinear and are also provided to assist tracking a tube within the analyzer and to control the mode of aspiration (speed, depth, through-the-stopper or not, and the like). This requires that an operator ensure that a marking is properly oriented in the chamber or carrier so as to be readable. After being placed on the analyzer, a predetermined, known portion of the original sample is aspirated from the tube and analytical tests conducted thereon.

U.S. Pat. No. 5,186,339 provides a sample tube rack having an aperture formed in the exterior wall to facilitate scanning the containers. U.S. Pat. No. 5,137,693 provides for an axial slot for optical viewing of a tube to ascertain its presence. U.S. Pat. No. 5,687,849 also provides a test tube holder having a viewing slot for observing tubes. U.S. Pat. No. 5,861,563 describes a sample tube racks having label windows so that the labels may be read or scanned without removing the tubes from the rack.

As the multi-tube carousel or individual sample tube carrier is moved throughout the sample handling system, however, a sample tube may unfortunately rotate within its holding chamber so that the identifying label is no longer visible for reading. One solution to this problem, described in U.S. Pat. No. 6,081,326 provides a sample tube carrier designed to enable reading of identification codes on the walls of sample tubes using a rotary drive to rotate the tube during a code reading process. This however makes the reading station complicated, more expensive and extends the time required for sample-tube identification.

From this description of prior art sample tube identification devices, there is a need for a simple, inexpensive device for stabilizing the orientation of a sample tube in a chamber or carrier as the sample tube is transported throughout a sample handling system. Sample tube carriers in particular suffer from vibration as a result of their generally lower weight compared to sample tube racks.

### SUMMARY OF THE INVENTION

It is therefore an object of this invention to provide an insert that can easily be placed within a sample tube chamber or carrier, the insert having features to ensure that the angular orientation of a sample tube originally placed within a sample tube chamber or carrier will be maintained as the sample tube is transported throughout a sample handling system. This and other advantages are accomplished by providing a sample tube carrier insert having a generally open conical-shaped bottom with opposing projections vertically extending above bottom portion so that the bottom of a sample tube is “interference-fit” between the projections.

### BRIEF DESCRIPTION OF THE DRAWINGS

For a better understanding of the invention as well as other objects and further features thereof, reference is made to the following detailed description of various preferred embodiments thereof, taken in connection with the accompanying drawings wherein:

FIG. 1 is a simplified schematic plan view of a prior art automated sample handling system including a conveyor transporting a sample tube rack in which the present invention may be advantageously employed;

FIGS. 2, 3 and 4 illustrate sample tube racks in which the sample tube insert of the present invention may be employed;

FIG. 5 is a perspective view of one embodiment of the sample tube rack insert illustrative of the present invention and adapted for use in the sample tube racks of FIGS. 2, 3 and 4;

FIG. 6 is a plan view of another embodiment of the sample tube rack insert illustrative of the present invention and adapted for use in the sample tube racks of FIGS. 2, 3 and 4;

FIG. 6A is a sectional view of the sample tube rack insert along line A-A of FIG. 6;

FIG. 7 is an enlarged plan view of a rib-like pattern formed on projections of the sample tube rack insert of FIG. 5; and

FIG. 8 illustrates the sample tube rack insert of FIG. 5 positioned in a sample rack transported by the automated sample handling system of FIG. 1 and having features so that tube identifying indices remain fully visible.

### DETAILED DESCRIPTION OF THE PREFERRED EMBODIMENTS

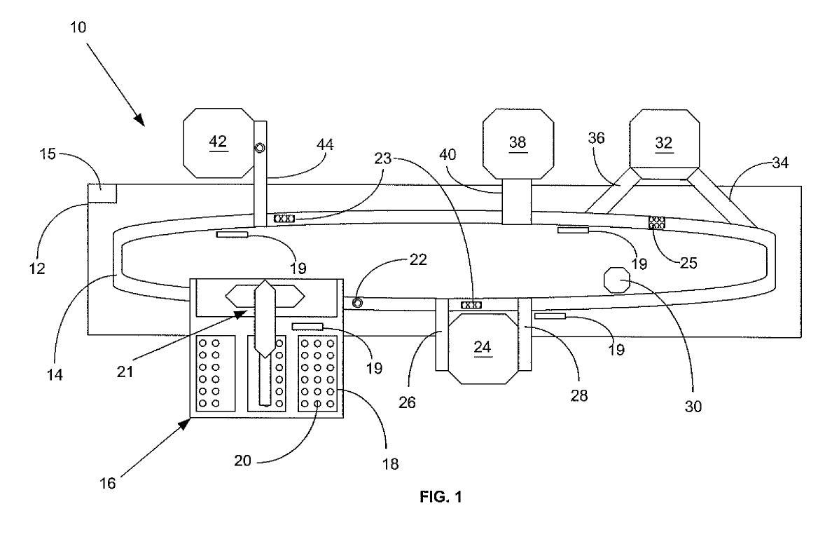

Referring to FIG. 1, there is illustrated a conventional Laboratory Automation System 10 (LAS 10) capable of automatically pre-processing as necessary multiple sample containers 20, typically sample test tubes 20, contained in single or multiple tube racks. Sample containers 20 may also be adapted to hold reagents, calibration solutions and/or Quality Control materials.

Typically, patient specimens to be automatically processed are provided to sample handling system 10 in multiple containers, such as test tubes 20, which can be capped. Each of the sample containers 20 is provided with container identification indicia, such as a bar code, indicating a patient's identification, as well as, optionally, the assay procedures to be accomplished upon the sample therein and/or time period for which a sample is to be retained after analysis in the event additional, “follow-on” testing is required. Racks 22, 23 and 25 described hereinafter also have identification indicia thereon for purposes of tracking.

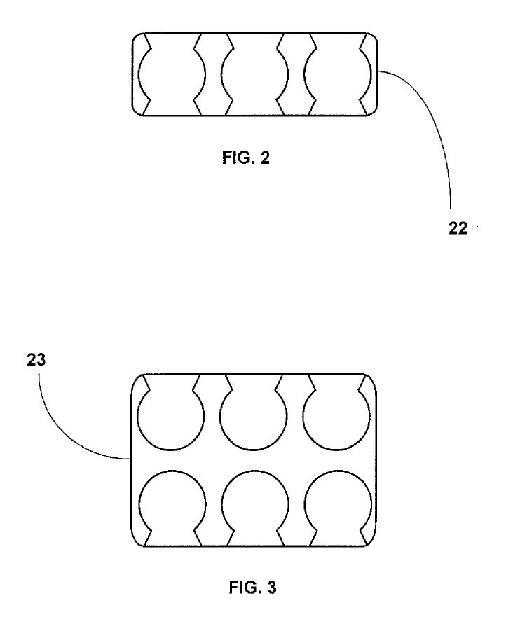

LAS 10 comprises an operating base 12 on which a belt-like conveyor track 14 transports at least one sample tube container 20 carried in sample tube racks 22, 23, and 25 described in conjunction with FIGS. 2-3-4 from a sample tube loading/unloading station 16 to an automated centrifuge 24 to an automated tube de-capper 30 for automatically removing caps from capped sample containers 20 and to one or more conventional clinical analyzers 32, 38, and 42 before returning each sample container 20 to the sample tube loading/unloading robotic station 16. It will be understood that more than three analyzers 32, 38, and 42 may be linked by conveyor track 14, but for purposes of simplicity, only three are shown. LAS 10 has a number of sensors, not illustrated, for detecting the location of a sample tube container 20 by means of identifying indicia 21 placed on each sample tube 20. Conventional bar-code readers may be employed in such tracking operations.

Centrifuge 24 and each analyzer 38, 42 and 32 are generally equipped with various robotic mechanisms 26 and 28, 40 and 44 or analyzer tracks 34 and 36, respectively, for removing a sample tube carrier 22 from conveyor track 14, moving the sample tube carrier 22 to and from centrifuge 24, to and from or into and out from analyzers 38, 42 and 32, respectively. Typically, the loading/unloading station 16 includes at least two X-Y-Z robotic arms 17 conventionally equipped with clamping robotic hands.

LAS 10 is controlled by a conventional computer 15 preferably a microprocessor based central processing unit CPU 15 housed as part of or separate from the system 10 to move the sample tube carrier 22 to each operating station 24, 30, 32, 38, 42 and 16 whereat various types of assay processing occurs. CPU 15 controls sample handling system 10 according to software, firmware, or hardware commands or circuits like those used on the Dimension® clinical chemistry analyzer sold by Dade Behring Inc. of Deerfield, Ill., and are typical of those skilled in the art of computer-based electromechanical control programming.

Incoming sample samples to be tested are typically contained in sample containers or tubes 20 supported in a single row sample tube rack 22 like seen in FIG. 2 and transportable by a sample tube rack transport system 36 comprising incoming lane 36A and outgoing lane 36B. Alternate support devices for carrying sample tubes 20 include dual row sample tube racks 23 like seen in FIG. 3 and a single sample tube rack 25 comprising a generally cylindrical lower carrier body 45 having a central, cylindrical hole depending therefrom and at least two vertically oriented arms 47 extending a distance upwards above body 45, arms 47 adapted to constrain tube 20 in a generally vertical and concentric orientation. Importantly, each of these exemplary sample tube racks 22, 23, 25 has at least one generally vertical opening 22V, 23V and 25V, respectively, to enable a bar code reader to read a linear bar code affixed to each tube 20 in order to identify the patient's identity.

Aliquot probe 44 is conventionally controlled by computer 15 to aspirate liquid sample from sample tubes 20 and to dispense one or more aliquot portions of the original patient sample into aliquot arrays 46 carried on an aliquot transport system 48 using probe 27 depending on the quantity of sample required to perform the requisite assays and to provide for at least one aliquot portion to be retained by analyzer 10.

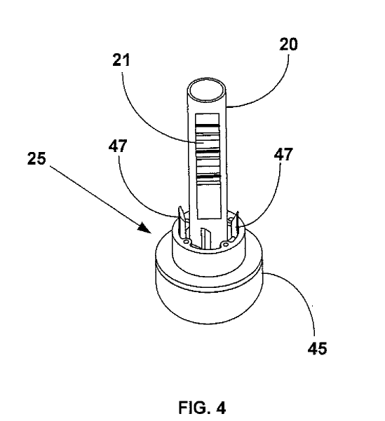

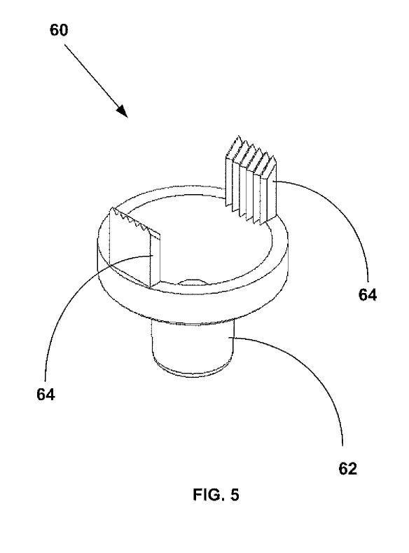

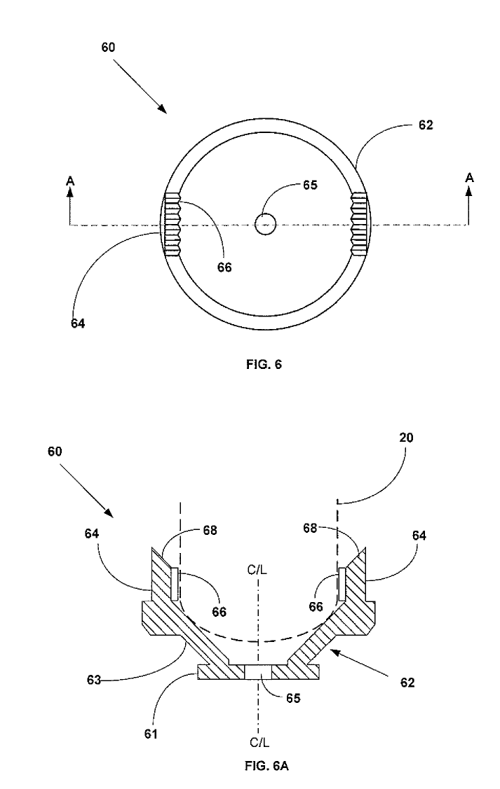

Sample tubes 20 are scanned using a conventional vision system 50 like illustrated in perspective in FIG. 5 and in the plan view of FIG. 6 utilized to provide for identification of the various test tubes 20 types that are potentially present in a rack 22, 23 or 25 through vertical opening 22V, 23V and 25V, respectively. The conveyor track 14 slides each rack 22, 23 or 25 such that each test tube 20 of interest is centered between a pair of front surface mirrors 52 positioned at an angle so that a beam of interrogating radiation emitted from a pair of imagers or bar code readers 54 is reflected back to the readers 54 for analysis. Exemplary readers 54 are 2-D CMOS imagers with 640×480 pixel resolution. The imagers 54 take a 2 dimensional VGA picture and process the image for markings and identification of sample tube 20. After the processing is complete for this one position, conveyor track 14 moves each rack 22, 23 or 25 such that the next test tube 20 is centered between mirrors 52 and the process is repeated.

From the above description of LAS 10, it can be appreciated that any event occurring within LAS that would inhibit access of readers 54 to imaging indicia 21 on sample tubes 20 would prevent proper operation of clinical analyzers 32, 38, and 42 and the like. Vibration of sample tube racks 22, 23 or 25 as they are transported throughout LAS 10 in particular has been found to cause a sample tube 20 to rotate within racks 22, 23 or 25 causing identifying indicia 21 to be obscured from readers 54. The present invention ameliorates such errors by providing a sample tube rack insert 60 for preventing rotation of a sample tube 20 carried in racks 22, 23 or 25 so that a bar code reader 54 or other vision system within LAS 10 can reliably read indicia 21 and thereby identify the contents of tube 20 and/or operations to be conducted thereon.

FIG. 5 is a perspective view of sample tube rack insert 60 of the present invention, sample tube rack insert 60 comprising a generally open conical-shaped bottom portion 62 with opposing projections 64 vertically extending above bottom portion 62. In use, insert 60 is placed proximate the bottom of each tube-carrying chamber 22C, 23C or 25C of racks 22, 23 or 25, respectively, prior to a tube 20 being placed therein. When a tube 20 is placed therein, the bottom portion of the tube 20 is “interference-fit” between projections 64 formed of a rubber-like material so that inadvertent rotation of such tube 20 is prevented. An important feature of insert 60 is a rib-like pattern 66 on the innermost surface of projections 64, the rib-like pattern 66 being effective in reducing friction between projections 64 and tube 20 that would otherwise hinder insertion of tube 20 into insert 60.

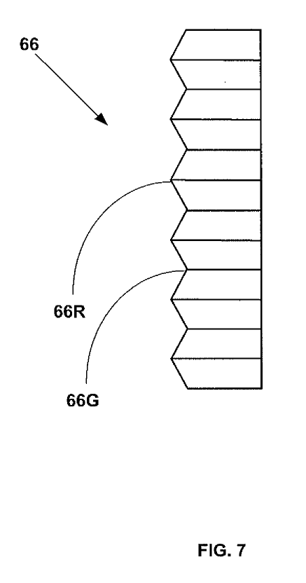

FIG. 6 is a plan view of insert 60 showing rib-like pattern 66 on the innermost surface of projections 64 holding a sample tube 20 (in dashed lines for clarity) and FIG. 6A is a sectional view of insert 60 taken along line A-A of FIG. 6. FIG. 6A illustrates sample tube insert 60 as symmetrical along line A-A and comprising a flat lowermost foot portion 61 having outwardly extending conical portion 63 attached thereto and culminating in vertically extending projections 64. A drain hole 65 may be provided in the bottom of conical-shaped bottom portion 62 if desired for liquid drainage. A phantom sample tube 20 is shown in dashed lines, illustrating the press-fit nature of interference between tube 20 and rib-like pattern 66 on the innermost surface of projections 64. The vertically extending projections 64 also have a chamfer 68 on their uppermost end adapted to guide tube 20 between projections 64. Optionally, chamfer 68 may include the rib-like pattern 66 on the innermost surface of projections 64 on its uppermost surface. FIG. 7 is an enlarged plan view of the rib-like pattern 66 on the innermost surface of projections 64, the rib-like pattern comprising a number of equally spaced, linear raised ridges 66R separated by a similar number of grooves 66G. In an exemplary embodiment, insert 60 and projections 64 are formed of a low durometer urethane elastomer thereby allowing insert 60 to accommodate minor variation in diameters of sample tubes 20 and still function. The ribs 66R and top chamfers 68 are intended to allow sample tube 20 to be inserted into insert 60 without bucking the vertically extending projections 64 by controlling the friction between projections 64 and tube 20. Buckling of the vertical projections 64 would prevent sample tube 20 from being properly inserted.

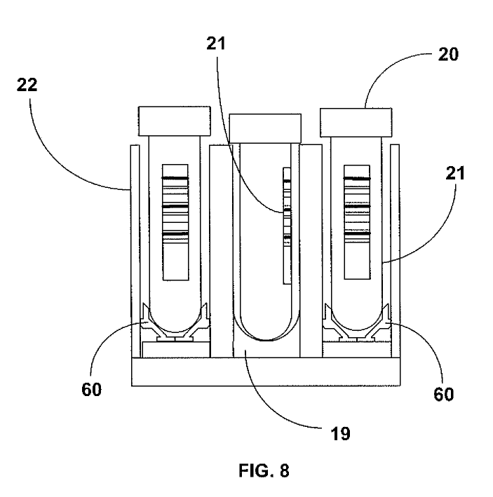

FIG. 8 shows the sample tube rack insert 60 illustrating the present invention positioned at the bottom of the rightmost and leftmost tube carrying chambers of sample rack 22 having maintained the orientation of tubes 20 carried therein so that indices 21 remain fully exposed through vertical openings in sample tube rack 22 as sample tube rack 22 is transported throughout LAS 10. In contrast, the central tube carrying chamber has a conventional insert or chamber bottom portion 19 and exemplified how the orientation of a tube 20 carried therein has rotated as the sample tube rack 22 is transported throughout LAS 10 causing indices 21 to be partially obscured and no longer fully visible within the vertical openings. The advantages of sample tube rack insert 60 having a rib-like pattern 66 on the innermost surface of projections 64 to maintain the vertical orientation of a tube supported thereby are realized in increased reliability and accuracy in reading indicia 21 affixed thereto.

Those skilled in the art will appreciate that the embodiments of the invention disclosed herein are illustrative of the principles of the invention and that other modifications may be employed which are still within the scope of the invention. Accordingly, the present invention is not limited to those embodiments precisely shown and described in the specification but only by the following claims.

What is claimed is:

1. A clinical sample analysis system comprising:
a sample analyzing module capable of analyzing a clinical sample;
a clinical workstation capable of transporting sample racks carrying sample tubes therein along a pathway proximate said sample analyzing module;
a sample transfer mechanism capable of transferring said sample container from said conveyor to said analyzing module; and,
an insert in said sample tube racks, said insert adapted to prevent rotation of the sample tube carried therein.

2. The clinical sample analysis system of claim 1 wherein said insert comprises a bottom portion with projections extending vertically upwards.

3. The clinical sample analysis system of claim 2 wherein said vertically extending projections form an interference fit with said tube.

4. The clinical sample analysis system of claim 2 wherein said vertically extending projections have a rib-like pattern on the innermost surface thereof.

5. The clinical sample analysis system of claim 2 wherein said vertically extending projections have an uppermost chamfer adapted to guide said tube between said projections.

6. The clinical sample analysis system of claim 5 wherein chamfer has a rib-like pattern on the uppermost surface thereof.

7. An insert for use in a sample tube rack, said insert adapted to prevent rotation of the sample tube carried therein, said insert comprising a bottom portion with projections extending vertically upwards and forming an interference fit with said tube.

8. The insert of claim 7 wherein said vertically extending projections have a rib-like pattern on the innermost surface thereof.

9. The insert of claim 7 wherein said vertically extending projections have an uppermost chamfer adapted to guide said tube between said projections.

10. The insert of claim 9 wherein chamfer has a rib-like pattern on the uppermost surface thereof.
